(19) United States
(12) Patent Application Publication
(10) Pub. No.: US 2020/0189958 A1
(43) Pub. Date: Jun. 18, 2020

(54) MANUFACTURING METHOD OF OPTICAL FIBER

(71) Applicant: SUMITOMO ELECTRIC INDUSTRIES, LTD., Osaka-shi, Osaka (JP)

(72) Inventors: Yuki KAWAGUCHI, Osaka-shi, Osaka (JP); Takahiro SAITO, Osaka-shi, Osaka (JP); Shuhei TOYOKAWA, Osaka-shi, Osaka (JP)

(73) Assignee: SUMITOMO ELECTRIC INDUSTRIES, LTD., Osaka-shi, Osaka (JP)

(21) Appl. No.: 16/640,455

(22) PCT Filed: Aug. 24, 2018
(86) PCT No.: PCT/JP2018/031363

§ 371 Date: Feb. 20, 2020

(30) Foreign Application Priority Data
Aug. 28, 2017 (JP) 2017-163204

(51) Int. Cl. C03B 37/027; C03B 25/10; C03B 37/10

(52) U.S. Cl. CPC C03B 37/027; C03B 25/10; C03B 2205/56; C03B 2205/42; C03B 37/10

(57) ABSTRACT

A method for manufacturing an optical fiber is disclosed. The method for manufacturing an optical fiber includes: drawing an optical fiber by heating an optical fiber preform inside a drawing furnace into which a first gas is introduced; and annealing the optical fiber by causing the optical fiber to pass through an annealing furnace disposed downstream of the drawing furnace and adjusted to a temperature lower than a temperature at which the optical fiber preform is heated. In the annealing, a second gas having a lower heat conductivity than the first gas is introduced into the annealing furnace through one or more gas introduction ports such that a total flow rate becomes 3 slm or higher, and a flow rate of the second gas per gas introduction port is adjusted to 30 slm or lower.

### TECHNICAL FIELD

The present disclosure relates to a method for manufacturing an optical fiber. The present application claims priority based on Japanese Patent Application No. 2017-163204, filed on Aug. 28, 2017, the entire contents disclosed in the application are incorporated herein by reference.

### BACKGROUND ART

Patent Literature 1 discloses a method for manufacturing an optical fiber. In this manufacturing method, an optical fiber preform is heated in a drawing furnace, and an optical fiber is drawn. Subsequently, the optical fiber is annealed in an annealing furnace adjusted to a temperature lower than a heating temperature of the optical fiber preform. Since the optical fiber is cooled at a desired cooling speed in the annealing furnace, a Rayleigh scattering intensity within the optical fiber is curbed and a transmission loss of the optical fiber to be manufactured is reduced.

### CITATION LIST

### Patent Literature

Patent Literature 1: PCT International Publication No. WO2004/007383

### SUMMARY OF INVENTION

The present disclosure provides a method for manufacturing an optical fiber. The method for manufacturing an optical fiber includes drawing an optical fiber by heating an optical fiber preform inside a drawing furnace into which a first gas is introduced; and annealing the optical fiber by causing the optical fiber to pass through an annealing furnace disposed downstream of the fiber drawing furnace and adjusted to a temperature lower than a temperature at which the optical fiber preform is heated. In the annealing, a second gas having a lower heat conductivity than the first gas is introduced into the annealing furnace through one or more gas introduction ports such that a total flow rate becomes 3 slm or higher, and a flow rate of the second gas per gas introduction port is adjusted to 30 slm or lower.

### BRIEF DESCRIPTION OF DRAWINGS

FIG. 1 is a schematic constitution diagram of an apparatus for manufacturing an optical fiber according to an embodiment.

### DESCRIPTION OF EMBODIMENT

### Problem to be Solved by Present Disclosure

From the viewpoint of improving productivity by raising a fiber drawing speed, it has been required to efficiently cool an optical fiber drawn from a fiber preform within a limited distance. In the method for manufacturing the optical fiber disclosed in Patent Literature 1, in order to achieve both efficient cooling and reduction of influence on fiber characteristics due to rapid cooling, an inert gas is introduced into the drawing furnace, and the optical fiber immediately after fiber drawing is rapidly cooled to 1,700° C. and is then led to the annealing furnace. However, if helium gas (He gas) or the like, that is, an inert gas is introduced into the drawing furnace and fiber drawing is performed at a high speed, He gas or the like dragged by the optical fiber may flow into the annealing furnace disposed downstream thereof. Since He gas or the like has a high heat conductivity, if He gas or the like having a high heat conductivity flows into the annealing furnace, the optical fiber is cooled faster than a desired speed in the annealing furnace. For this reason, there is concern that a transmission loss of the optical fiber to be manufactured may be affected, and therefore further improvement is desired.

The inventors have devised that inflow of a gas introduced into a drawing furnace into an annealing furnace is curbed by introducing a gas having a lower heat conductivity than an inert gas (for example, He gas) introduced into the drawing furnace into the annealing furnace. On the other hand, the inventors have also found a problem in which if a gas is introduced into an annealing furnace at an excessive flow rate, inflow of a gas introduced into a drawing furnace into the annealing furnace can be curbed, but fluctuation in outer diameter of an optical fiber increases. If fluctuation in outer diameter of an optical fiber increases, a connection loss in connector connection increases, for example. Therefore, the inventors have further conducted many investigations and have come to completion of the present invention.

### Effects of Present Disclosure

According to the present disclosure, it is possible to provide a method for manufacturing of an optical fiber, in which fluctuation in outer diameter of the optical fiber is curbed and a transmission loss of the optical fiber is reduced.

### Description of Embodiment of Present Disclosure

An embodiment of the present disclosure will be enumerated and described. A method for manufacturing an optical fiber according to the embodiment of the present disclosure includes drawing an optical fiber by heating an optical fiber preform inside a drawing furnace into which a first gas is introduced; and annealing the optical fiber by causing the optical fiber to pass through an annealing furnace disposed downstream of the drawing furnace and adjusted to a temperature lower than a temperature at which the optical fiber preform is heated. In the annealing, a second gas having a lower heat conductivity than the first gas is introduced into the annealing furnace through one or more gas introduction ports such that a total flow rate becomes 3 slm or higher, and a flow rate of the second gas per gas introduction port is adjusted to 30 slm or lower. The unit “slm” used herein is a unit indicating a flow rate per minute in liters in an environment of 1 atm and 0° C.

In the method for manufacturing an optical fiber, the second gas having a lower heat conductivity than the first gas introduced into the drawing furnace is introduced into the annealing furnace such that the total flow rate becomes 3 slm or higher. Accordingly, inflow of the first gas into the annealing furnace can be curbed effectively. In this manner, inflow of the first gas having a high heat conductivity into the annealing furnace is curbed. Therefore, an optical fiber can be cooled at a desired cooling speed in the annealing furnace, and a transmission loss of the optical fiber can be reduced. On the other hand, in the method for manufacturing an optical fiber, the flow rate of the second gas per gas introduction port is adjusted such that it becomes 30 slm or lower. Accordingly, influence of the second gas on the outer diameter of an annealed optical fiber can be curbed. As a result, fluctuation in outer diameter of the optical fiber can be curbed. In this manner, according to the method for manufacturing an optical fiber, fluctuation in outer diameter of the optical fiber can be curbed and a transmission loss of the optical fiber can be reduced.

In the annealing, the optical fiber having a temperature within a range of 1,300° C. to 1,650° C. may be led to the annealing furnace. If the temperature of an optical fiber led to the annealing furnace is lower than 1,300° C., the effect of annealing is unlikely to be achieved because the optical fiber is rapidly cooled before it enters the annealing furnace, and it is solidified to a certain degree. On the other hand, if the temperature of an optical fiber led to the annealing furnace is higher than 1,650° C., the optical fiber cannot be cooled sufficiently. In this manner, when the temperature of an optical fiber led to the annealing furnace is within a temperature range of 1,300° C. to 1,650° C., a transmission loss of the optical fiber can be further reduced.

In the annealing, a temperature of the annealing furnace may be set within a range of 800° C. to 1,400° C. If the temperature of the annealing furnace is lower than 800° C., an optical fiber is rapidly cooled in the annealing furnace. Thus, the effect of annealing is unlikely to be achieved. On the other hand, if the temperature of the annealing furnace is higher than 1,400° C., an optical fiber cannot be cooled sufficiently. In this manner, when the temperature of the annealing furnace is set within a temperature range of 800° C. to 1,400° C., a transmission loss of the optical fiber can be further reduced.

In the annealing, the optical fiber may be led to the annealing furnace at a fiber drawing speed of 2,000 m/min or faster. When the fiber drawing speed is 2,000 m/min or faster, the first gas is dragged by an optical fiber and is likely to flow into the annealing furnace. Even in this case as well, according to the method for manufacturing an optical fiber, fluctuation in outer diameter of the optical fiber can be curbed and a transmission loss of the optical fiber can be reduced. Accordingly, an optical fiber having a good quality can be produced at a high speed, and thus productivity can be improved.

The first gas may be helium gas, and the second gas may be nitrogen, air, or an inert gas other than the helium gas. If the second gas is nitrogen, air, or an inert gas other than the helium gas, a better effect of annealing can be achieved and a transmission loss of the optical fiber can be further reduced.

In the annealing, the second gas may be introduced through the gas introduction ports. In this case, the second gas can be introduced into the annealing furnace efficiently or more uniformly, and thus an optical fiber having more favorable characteristics (for example, a fewer transmission loss) can be produced.

### Details of Embodiment of Present Disclosure

Specific examples of a method for manufacturing an optical fiber and a apparatus for manufacturing the same according to the embodiment of the present disclosure will be described below with reference to the drawings. The present invention is not limited to the examples. The present invention is indicated by the claims, and it is intended to include all changes within meanings and a range equivalent to the claims. In the following description, the same reference signs are applied to the same elements in description of the drawings, and duplicate description will be omitted.

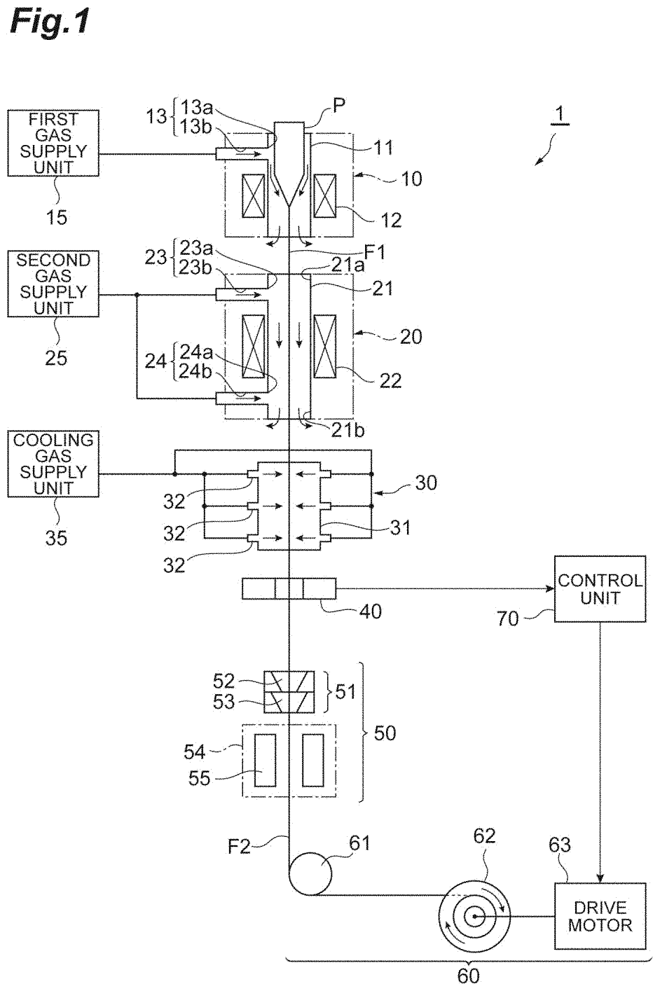

With reference to FIG. 1, a constitution of the apparatus for manufacturing an optical fiber according to the present embodiment will be described. As illustrated in FIG. 1, a manufacturing apparatus 1 of an optical fiber (which will hereinafter be simply referred to as “a manufacturing apparatus 1”) is an apparatus for producing an optical fiber F2 by drawing an optical fiber F1 from an optical fiber preform P and coating the drawn optical fiber F1 with a resin. The manufacturing apparatus 1 includes a drawing furnace 10 drawing furnace 10, a first gas supply unit 15, an annealing furnace 20, a second gas supply unit 25, a cooling device 30, a cooling gas supply unit 35, an outer diameter measuring instrument 40, a resin coating device 50, a winding mechanism 60, and a control unit 70. The drawing furnace 10, the annealing furnace 20, the cooling device 30, the outer diameter measuring instrument 40, and the resin coating device 50 are sequentially installed in this order in a vertical direction. The optical fiber F1 travels in the vertical direction in the order of the drawing furnace 10, the annealing furnace 20, the cooling device 30, the outer diameter measuring instrument 40, and the resin coating device 50.

The drawing furnace 10 is a heating furnace for drawing the optical fiber F1 by heating the optical fiber preform P. The drawing furnace 10 has a furnace core tube 11 for accommodating the optical fiber preform P, a heater 12 for heating the optical fiber preform P disposed inside the furnace core tube 11, and a first gas introduction mechanism 13 for introducing a gas supplied from the first gas supply unit 15 into the furnace core tube 11.

The optical fiber preform P mainly consists of quartz glass and has a core region and a cladding region provided in the outer circumference of the core region. For example, germanium is added to the core region. The core region of the optical fiber preform P may not include an additive such as germanium and may be constituted of pure quartz. The furnace core tube 11 has a tubular shape penetrating the inside of the drawing furnace 10 in the vertical direction. The heater 12 is disposed concentrically with the furnace core tube 11 and is positioned such that a distal end of the optical fiber preform P disposed inside the furnace core tube 11 is surrounded.

The first gas introduction mechanism 13 introduces the first gas into the drawing furnace 10. The first gas introduction mechanism 13 has a first gas introduction port 13a connected to an inner wall of the furnace core tube 11 of the drawing furnace 10, and a first gas introduction tube 13b connected to the first gas introduction port 13a and penetrating the drawing furnace 10 to the outward side. The first gas introduction tube 13b is connected to the first gas supply unit 15 opposite to the first gas introduction port 13a. The first gas supply unit 15 supplies the first gas to the drawing furnace 10 through the first gas introduction mechanism 13. For example, the first gas is helium gas (which will hereinafter be referred to as “He gas”). The first gas is not limited to He gas, and a different inert gas may be adopted as long as it can perform cooling or the like without affecting the constitution of the drawn optical fiber F1.

The annealing furnace 20 is disposed downstream of the drawing furnace 10 and anneals the optical fiber F1 drawn from the drawing furnace 10. The annealing furnace 20 has a furnace core tube 21 through which the optical fiber F1 drawn from the drawing furnace 10 passes, a heater 22 for heating the optical fiber F1, and second gas introduction mechanisms 23 and 24 for introducing the second gas supplied from the second gas supply unit 25 into the furnace core tube 21. The furnace core tube 21 has a tubular shape penetrating the inside of the annealing furnace 20 in the vertical direction. The length of the furnace core tube 21 in the vertical direction is 3 m, for example. The diameters of an entrance 21a and an exit 21b of the furnace core tube 21 are within a range of 20 mm to 60 mm, for example.

The heater 22 is disposed concentrically with the furnace core tube 21. In the present embodiment, the heater 22 heats the inside (furnace core tube 21) of the annealing furnace 20 at a temperature lower than a temperature at which the optical fiber preform P is heated inside the drawing furnace 10 such that the optical fiber F1 which has passed through the furnace core tube 21 is annealed at a cooling speed of 5,000° C./sec or slower. The temperature of the annealing furnace 20 (inside the furnace core tube 21) is set to a predetermined temperature within a range of 800° C. to 1,400° C., for example, using heat applied from the heater 22. When the temperature of the optical fiber F1 at the entrance 21a of the furnace core tube 21 is Ts (° C.), the temperature of the optical fiber F1 at the exit 21b of the furnace core tube 21 is Te (° C.), the fiber drawing speed of a glass fiber is Vf (m/sec), and the length of the furnace core tube 21 in the vertical direction is L (m), the cooling speed of the optical fiber F1 is defined by (Ts−Te)×Vf/L.

The second gas introduction mechanisms 23 and 24 introduce the second gas into the annealing furnace 20. The second gas introduction mechanisms 23 and 24 respectively have second gas introduction ports 23a and 24a connected to an inner wall of the furnace core tube 21 of the annealing furnace 20, and second gas introduction tubes 23b and 24b connected to the second gas introduction ports 23a and 24a and penetrating the annealing furnace 20 to the outward side.

The second gas introduction port 23a and the second gas introduction tube 23b are disposed on a side closer to the entrance 21a than an upper end side of the annealing furnace 20, that is, the exit 21b of the furnace core tube 21. The second gas introduction port 24a and the second gas introduction tube 24b are disposed on a side closer to the exit 21b than a lower end side of the annealing furnace 20, that is, the entrance 21a of the furnace core tube 21. In the annealing furnace 20, the number of each of the second gas introduction ports and the second gas introduction tubes (second gas introduction mechanisms) may be one, three, or larger. Each of the second gas introduction tubes 23b and 24b is connected to the second gas supply unit 25 opposite to the second gas introduction ports 23a and 24a. The second gas supply unit 25 supplies the second gas to the annealing furnace 20 through the second gas introduction mechanisms 23 and 24.

The second gas introduction mechanisms 23 and 24 introduce the second gas into the annealing furnace 20 such that the total flow rate of the second gas becomes 3 slm or higher. Specifically, the second gas introduction mechanisms 23 and 24 are adjusted such that the sum of the flow rate of the second gas introduced through the second gas introduction port 23a and the flow rate of the second gas introduced through the second gas introduction port 24a becomes 3 slm or higher. In addition, in the second gas introduction mechanisms 23 and 24, the upper limit for an inflow gas is adjusted such that the flow rate of the second gas per gas introduction port becomes 30 slm or lower. In other words, the flow rate of the second gas introduced through each of the second gas introduction ports 23a and 24a is 30 slm or lower. For example, air can be used as the second gas, but there is no limitation thereto. The second gas may be an inert gas such as an argon gas having a lower heat conductivity than He gas, or nitrogen.

The cooling device 30 rapidly cools the optical fiber F1. The cooling device 30 has a cylindrical tube 31 through which the optical fiber F1 passes, and a plurality of nozzles 32 connected to an inner wall of the cylindrical tube 31. The cooling gas supply unit 35 is connected to the plurality of nozzles 32. The cooling device 30 introduces a cooling gas supplied from the cooling gas supply unit 35 into the cylindrical tube 31 through the plurality of nozzles 32. For example, helium gas is used as a cooling gas.

The outer diameter measuring instrument 40 continuously measures the outer diameter of the optical fiber F1 rapidly cooled by the cooling device 30. The outer diameter measuring instrument 40 outputs data of measured outer diameters to the control unit 70.

The resin coating device 50 applies a resin to the optical fiber F1 which has passed through the outer diameter measuring instrument 40 and forms the optical fiber F2 coated with the resin. The resin coating device 50 has a coating die 51 and a resin curing portion 54 sequentially from the outer diameter measuring instrument 40 in the vertical direction.

The coating die 51 applies two layers of UV resins 52 and 53 to the optical fiber F1 which has passed through the inside. The resin curing portion 54 cures the UV resins 52 and 53 applied to the optical fiber F1 using UV rays emitted from a UV lamp 55. Accordingly, the optical fiber F2 is formed. Here, an example in which an optical fiber is collectively coated with two layers of resins and is cured has been described. However, a tandem constitution in which resins are applied one layer at a time and are cured may be adopted.

The winding mechanism 60 has a guide roller 61, a drum 62, and a drive motor 63. The guide roller 61 guides the optical fiber F2 in a rear stage of the resin coating device 50 and changes a drawing direction of the optical fiber F2 to a horizontal direction, for example. The drum 62 winds the optical fiber F2 in a rear stage of the guide roller 61. The fiber drawing speed of the optical fiber F2 depends on a speed at which the optical fiber F2 is wound around the drum 62. The drum 62 rotates due to a driving force applied from the drive motor 63.

The drive motor 63 is controlled by the control unit 70. Specifically, the control unit 70 is connected to the outer diameter measuring instrument 40 such that they can communicate with each other, and the rotation speed of the drive motor 63 is determined such that the outer diameter of the optical fiber F1 measured by the outer diameter measuring instrument 40 meets a value set in advance. The outer diameter measuring instrument 40 is disposed between the cooling device 30 and the resin coating device 50, performs on-line measurement of the outer diameter of the optical fiber F1 which has passed through the cooling device 30, and transmits measurement results to the control unit 70.

Next, the method for manufacturing an optical fiber using the manufacturing apparatus 1 described above will be described.

First, the optical fiber preform P having the core region and the cladding region provided in the outer circumference of the core region is prepared inside the furnace core tube 11 of the drawing furnace 10. Next, the first gas (for example, He gas) supplied from the first gas supply unit 15 is introduced into the drawing furnace 10 by the first gas introduction mechanism 13. Accordingly, the inside of the furnace core tube 11 is in a first gas atmosphere. Next, a lower end of the optical fiber preform P is heated and softened by the heater 12 inside the drawing furnace 10 into which the first gas is introduced, and the optical fiber F1 is drawn at a predetermined fiber drawing speed (fiber drawing step). The control unit 70 controls a speed at which the optical fiber F1 is wound around the drum 62, that is, the fiber drawing speed by determining the rotation speed of the drive motor 63. The fiber drawing speed can be set to 2,000 m/sec, for example. Since the first gas has been introduced, an optical fiber immediately after fiber drawing is rapidly cooled to approximately 1,700° C., for example.

The optical fiber F1 drawn from the drawing furnace 10 is led to the annealing furnace 20 disposed downstream of the drawing furnace 10 (annealing step). For example, the optical fiber F1 within a range of 1,300° C. to 1,650° C. is led to the annealing furnace 20 at a fiber drawing speed of 2,000 m/min or faster. In the annealing step, the annealing furnace 20 adjusts the temperature of the furnace core tube 21 to a temperature lower than the temperature at which the optical fiber preform P is heated inside the drawing furnace 10 using heat applied from the heater 22. That is, the optical fiber F1 is annealed by passing through the annealing furnace 20 adjusted to a temperature lower than the temperature at which the optical fiber preform P is heated inside the drawing furnace 10. Specifically, in the annealing step, the temperature of the annealing furnace 20 (inside the furnace core tube 21) is adjusted to a predetermined temperature within a range of 800° C. to 1,400° C., for example, using heat applied from the heater 22.

In addition, in the annealing step, the second gas (for example, an argon gas or air) having a lower heat conductivity than the first gas is introduced into the annealing furnace 20 through two second gas introduction ports 23a and 24a such that the flow rate becomes 3 slm or higher. That is, the total amount of the introduction amount of the second gas introduced into the annealing furnace 20 through the second gas introduction port 23a and the introduction amount of the second gas introduced into the annealing furnace 20 through the second gas introduction port 24a is adjusted such that it becomes 3 slm or higher. On the other hand, in the present embodiment, the flow rate is adjusted such that the maximum flow rate of the second gas per gas introduction port becomes 30 slm or lower. That is, the flow rate is adjusted such that the introduction amount of the second gas introduced through each of the second gas introduction ports 23a and 24a becomes 30 slm or lower. In the example illustrated in FIG. 1, in the annealing step, the second gas is introduced into the annealing furnace 20 through the two second gas introduction ports 23a and 24a. However, the second gas may be introduced into the annealing furnace 20 through one second gas introduction port 23a or 24a, or the second gas may be introduced into the annealing furnace 20 through three or more second gas introduction ports. In all cases, the total amount of the second gas introduced into the annealing furnace 20 is 3 slm or higher, and the flow rate is adjusted such that the maximum flow rate of the second gas per gas introduction port becomes 30 slm or lower.

The optical fiber F1 which has passed through the annealing furnace 20 is led to the cooling device 30. The cooling device 30 further cools the optical fiber F1 which has passed through the inside to a predetermined temperature (cooling step). Further, a cooling gas supplied from the cooling gas supply unit 35 is introduced to the cylindrical tube 31 via the plurality of nozzles 32, and the optical fiber F1 is forcibly cooled by the cooling gas.

The optical fiber F1 which has passed through the cooling device 30 is led to the outer diameter measuring instrument 40. The outer diameter measuring instrument 40 measures the outer diameter of the optical fiber F1 which has passed through the inside and transmits measurement results to the control unit 70. The control unit 70 performs feedback control of the rotation speed of the drive motor 63 by computing the rotation speed of the drive motor 63 driving the drum 62 such that the measurement results received from the outer diameter measuring instrument 40 meet values set in advance.

The optical fiber F1 which has passed through the outer diameter measuring instrument 40 is led to the resin coating device 50. The resin coating device 50 applies the UV resins 52 and 53 to the optical fiber F1 and forms the optical fiber F2. Specifically, the resin coating device 50 applies the UV resins 52 and 53 using the coating die 51 and cures the UV resins 52 and 53 using the resin curing portion 54. The optical fiber F2 formed by the resin coating device 50 is wound by the drum 62 via the guide roller 61.

As described above, in the method for manufacturing an optical fiber according to the present embodiment, the second gas (for example, an argon gas or air) having a lower heat conductivity than the first gas (for example, He gas) introduced into the drawing furnace 10 is introduced into the annealing furnace 20 such that the total flow rate becomes 3 slm or higher. In this manner, inflow of the first gas into the annealing furnace 20 can be curbed effectively by actively introducing a certain amount of gas into the annealing furnace 20. Further, since inflow of the first gas having a higher heat conductivity than the second gas into the annealing furnace 20 is prevented, the optical fiber F1 can be cooled in the annealing furnace 20 at a desired cooling speed. As a result, a transmission loss of the optical fibers F1 and F2 can be reduced. On the other hand, in the method for manufacturing an optical fiber, in the annealing furnace 20, the flow rate of the second gas per gas introduction port is adjusted such that it becomes 30 slm or lower. In this manner, although a gas is introduced into the annealing furnace 20, the magnitude (flow rate) thereof is limited such that the outer diameter of the optical fiber F1 is not affected by the introduced gas. As a result, fluctuation in outer diameter of the optical fibers F1 and F2 can be curbed. As above, according to the method for manufacturing an optical fiber or the apparatus for manufacturing the same of the present embodiment, fluctuation in outer diameter of the optical fiber can be curbed and a transmission loss of the optical fiber can be reduced.

In the manufacturing method according to the present embodiment, the optical fiber F1 within a range of 1,300° C. to 1,650° C. is led to the annealing furnace 20 in the annealing step. If the temperature of the optical fiber F1 led to the annealing furnace is lower than 1,300° C., the effect of annealing is unlikely to be achieved because the optical fiber F1 is rapidly cooled before it enters the annealing furnace 20, and it is solidified to a certain degree. On the other hand, if the temperature of the optical fiber F1 led to the annealing furnace 20 is higher than 1,650° C., the optical fiber cannot be cooled sufficiently. In this manner, when the temperature of the optical fiber F1 led to the annealing furnace 20 is within a temperature range of 1,300° C. to 1,650° C., a transmission loss of the optical fiber F1 can be further reduced.

In the manufacturing method according to the present embodiment, the temperature of the annealing furnace 20 is set within a range of 800° C. to 1,400° C. in the annealing step. If the temperature of the annealing furnace 20 is lower than 800° C., the optical fiber is rapidly cooled in the annealing furnace 20. Thus, the effect of annealing is unlikely to be achieved. On the other hand, if the temperature of the annealing furnace 20 is higher than 1,400° C., the optical fiber F1 cannot be cooled sufficiently. In this manner, when the temperature of the annealing furnace 20 is within a temperature range of 800° C. to 1,400° C., a transmission loss of the optical fiber F1 can be further reduced.

In the manufacturing method according to the present embodiment, the first gas is helium gas, and the second gas is an inert gas other than helium gas, nitrogen, or air. If the second gas is an inert gas other than helium gas, nitrogen, or air, a better effect of annealing can be achieved and a transmission loss of the optical fiber can be further reduced.

In the manufacturing method according to the present embodiment, the optical fiber F1 is led to the annealing furnace 20 at a fiber drawing speed of 2,000 m/min or faster in the annealing step. In this manner, when the fiber drawing speed is 2,000 m/min or faster, the first gas is dragged by the optical fiber F1 and is likely to flow into the annealing furnace 20. However, according to the manufacturing method of an optical fiber of the present embodiment, a predetermined amount of the second gas is introduced into the annealing furnace 20. Thus, inflow of the first gas from the drawing furnace 10 to the annealing furnace 20 can be prevented, and while curbing of fluctuation in outer diameter of the optical fiber F1 and reduction of a transmission loss of the optical fiber F1 is realized, the manufacturing speed of the optical fibers F1 and F2 can be improved. From the viewpoint of manufacturing efficiency, it is preferable that the fiber drawing speed be 2,000 m/min or faster. However, when an optical fiber having a higher quality is manufactured or the like, the fiber drawing speed may be slower than 2,000 m/min.

Hereinabove, an embodiment according to the present disclosure has been described. However, the present invention is not necessarily limited to the embodiment described above, and various changes can be made within a range not departing from the gist thereof. For example, regarding a specific constitution of the manufacturing apparatus of an optical fiber, FIG. 1 illustrates an example thereof, and a manufacturing apparatus having a different constitution may be used as long as the manufacturing method described above can be realized. In addition, the core region of the optical fiber preform P does not have to include an additive such as germanium. In this case, fewer impurities are included in the core region, and thus a transmission loss in an optical fiber can be further reduced.

### EXAMPLES

Hereinafter, the present disclosure will be described more specifically based on examples and comparative examples, but the present invention is not limited to the following examples.

A plurality of optical fibers differing from each other in various conditions for manufacturing an optical fiber were produced using a manufacturing apparatus of an optical fiber having a constitution similar to that of the manufacturing apparatus 1 in regard to points other than the various conditions, and fluctuation in outer diameter and a transmission loss of the produced optical fiber were compared to each other. In all cases of Examples 1 to 12 and Comparative Examples 1 to 5, helium gas was introduced into the drawing furnace 10 as the first gas. Germanium was added to the core regions of the produced optical fibers. Table 1 shows various conditions other than this.

Generally, it is assumed that since the first gas having a faster fiber drawing speed is more likely to be dragged into the annealing furnace 20, a transmission loss is also significant. As described above, particularly when the fiber drawing speed is 2,000 m/min or faster, the first gas is dragged by the optical fiber F1 and is likely to flow into the annealing furnace 20. All cases of Examples 1 to 12 and Comparative Examples 1 to 5 show a case where the fiber drawing speed is 2,000 m/min or faster.

Table 1 shows fluctuation in outer diameter and transmission losses of the optical fibers manufactured under each of the various conditions. The fluctuation in outer diameter of the optical fiber indicates a value (3σ) three times a standard deviation σ in the outer diameter of the optical fiber. The transmission loss indicates a measurement value measured by an optical time domain reflectometer (OTDR) using light having a wavelength of 1,550 nm. When the fluctuation in outer diameter of the optical fiber was 0.5 μm or greater, it was regarded as an inappropriate value and “poor” was entered together with the measurement value in the column of “Fluctuation in outer diameter”. When the transmission loss was 0.185 or greater, it was regarded as an inappropriate value and “poor” was entered together with the measurement value in the column of “Transmission loss”.

TABLE 1

| | | | Introduction | Introduction | Temperature | | |
|---|---|---|---|---|---|---|---|
| | Fiber drawing | Kind of | amount of second | amount of second | of annealing | Fluctuation in | transmission |
| | speed | second | gas (upper end) | gas (lower end) | furnace | outer diameter | loss |
| | [m/min] | gas | [slm] | [slm] | [° C.] | [μm] | [dB/km] |
| Example 1 | 2,000 | air | 5 | 0 | 1,000 | 0.1 | 0.176 |
| Example 2 | 2,400 | air | 0 | 10 | 1,000 | 0.2 | 0.178 |
| Example 3 | 2,800 | air | 5 | 5 | 1,200 | 0.2 | 0.181 |
| Example 4 | 3,200 | air | 10 | 0 | 1,000 | 0.1 | 0.180 |
| Example 5 | 3,400 | air | 0 | 20 | 1,400 | 0.3 | 0.179 |
| Example 6 | 3,800 | air | 3 | 0 | 1,000 | 0.4 | 0.180 |
| Example 7 | 2,000 | argon | 0 | 20 | 800 | 0.2 | 0.181 |
| Example 8 | 2,400 | argon | 10 | 0 | 1,100 | 0.1 | 0.178 |
| Example 9 | 2,800 | argon | 0 | 20 | 1,300 | 0.1 | 0.179 |
| Example 10 | 3,200 | argon | 0 | 25 | 1,100 | 0.4 | 0.180 |
| Example 11 | 3,400 | argon | 10 | 10 | 1,300 | 0.3 | 0.181 |
| Example 12 | 3,800 | argon | 5 | 0 | 1,000 | 0.3 | 0.181 |
| Comparative | 2,000 | — | — | — | — | 0.1 | 0.187 |
| Example 1 | | | | | | | (poor) |
| Comparative | 2,000 | air | 0 | 35 | 1,000 | 0.8 | 0.181 |
| Example 2 | | | | | | (poor) | |
| Comparative | 2,200 | air | 0 | 2 | 1,000 | 0.1 | 0.185 |
| Example 3 | | | | | | | (poor) |
| Comparative | 2,000 | argon | 0 | 35 | 1,000 | 1.2 | 0.176 |
| Example 4 | | | | | | (poor) | |
| Comparative | 2,400 | air | 0 | 2 | 1,000 | 0.1 | 0.185 |
| Example 5 | | | | | | | (poor) |

In Example 1, air was introduced as the second gas into the annealing furnace 20 from the upper end (second gas introduction mechanism 23, the same applies hereinafter) thereof at 5 slm, and in a state where the temperature inside the annealing furnace 20 was set to 1,000° C., the optical fiber F1 was drawn at a fiber drawing speed of 2,000 m/min. In Example 2, air was introduced as the second gas into the annealing furnace 20 from the lower end (second gas introduction mechanism 24, the same applies hereinafter) thereof at 10 slm, and in a state where the temperature inside the annealing furnace 20 was set to 1,000° C., the optical fiber F1 was drawn at a fiber drawing speed of 2,400 m/min. In Example 3, air was introduced as the second gas into the annealing furnace 20 from each of the upper end and the lower end thereof at 5 slm, and in a state where the temperature inside the annealing furnace 20 was set to 1,200° C., the optical fiber F1 was drawn at a fiber drawing speed of 2,800 m/min.

In Example 4, air was introduced as the second gas into the annealing furnace 20 from the upper end thereof at 10 slm, and in a state where the temperature inside the annealing furnace 20 was set to 1,000° C., the optical fiber F1 was drawn at a fiber drawing speed of 3,200 m/min. In Example 5, air was introduced as the second gas into the annealing furnace 20 from the lower end thereof at 20 slm, and in a state where the temperature inside the annealing furnace 20 was set to 1,400° C., the optical fiber F1 was drawn at a fiber drawing speed of 3,400 m/min. In Example 6, air was introduced as the second gas into the annealing furnace 20 from the upper end thereof at 3 slm, and in a state where the temperature inside the annealing furnace 20 was set to 1,000° C., the optical fiber F1 was drawn at a fiber drawing speed of 3,800 m/min.

In Example 7, an argon gas was introduced as the second gas into the annealing furnace 20 from the lower end thereof at 20 slm, and in a state where the temperature inside the annealing furnace 20 was set to 800° C., the optical fiber F1 was drawn at a fiber drawing speed of 2,000 m/min. In Example 8, an argon gas was introduced as the second gas into the annealing furnace 20 from the upper end of the annealing furnace 20 at 10 slm, and in a state where the temperature inside the annealing furnace 20 was set to 1,100° C., the optical fiber F1 was drawn at a fiber drawing speed of 2,400 m/min. In Example 9, an argon gas was introduced as the second gas into the annealing furnace 20 from the lower end thereof at 20 slm, and in a state where the temperature inside the annealing furnace 20 was set to 1,300° C., the optical fiber F1 was drawn at a fiber drawing speed of 2,800 m/min.

In Example 10, an argon gas was introduced as the second gas into the annealing furnace 20 from the lower end thereof at 25 slm, and in a state where the temperature inside the annealing furnace 20 was set to 1,100° C., the optical fiber F1 was drawn at a fiber drawing speed of 3,200 m/min. In Example 11, an argon gas was introduced as the second gas into the annealing furnace 20 from each of the upper end and the lower end of the annealing furnace 20 at 10 slm, and in a state where the temperature inside the annealing furnace 20 was set to 1,300° C., the optical fiber F1 was drawn at a fiber drawing speed of 3,400 m/min. In Example 12, an argon gas was introduced as the second gas into the annealing furnace 20 from the upper end thereof at 5 slm, and in a state where the temperature inside the annealing furnace 20 was set to 1,000° C., the optical fiber F1 was drawn at a fiber drawing speed of 3,800 m/min.

As described above, in Examples 1 to 12, the second gas was introduced into the annealing furnace 20 such that the total flow rate of the second gas became 3 slm or higher. Accordingly, it could be confirmed that inflow of the first gas into the annealing furnace 20 was curbed and the transmission losses of the optical fibers F1 and F2 were reduced to 0.181 dB/km or lower. In addition, in Examples 1 to 12, in the annealing furnace 20, the flow rate of the second gas per gas introduction port was adjusted such that it becomes 30 slm or lower. Accordingly, it could be confirmed that the fluctuation in outer diameter of the optical fiber F1 was curbed to 0.5 μm or smaller. In addition, from Examples 1 to 12, it could be confirmed that a transmission loss could be reduced even if the second gas was air or an argon gas.

On the other hand, in Comparative Example 1, an optical fiber was drawn at a fiber drawing speed of 2,000 m/min without being led to the annealing furnace. In this case, although the fluctuation in outer diameter of the optical fiber was favorable, the transmission loss was 0.187 dB/km, which was high.

In Comparative Example 3, air was introduced as the second gas into the annealing furnace from the lower end thereof at 2 slm, and in a state where the temperature inside the annealing furnace 20 was set to 1,000° C., the optical fiber was drawn at a fiber drawing speed of 2,200 m/min. In this case, although the value of the fluctuation in outer diameter of the optical fiber was favorable, the transmission loss was 0.185 dB/km, which was high. In Comparative Example 5, air was introduced as the second gas into the annealing furnace 20 from the lower end thereof at 2 slm, and in a state where the temperature inside the annealing furnace was set to 1,000° C., the optical fiber was drawn at a fiber drawing speed of 2,400 m/min. Although the value of the fluctuation in outer diameter of the optical fiber was favorable in this case, the transmission loss was 0.185 dB/km, which was high.

In Comparative Example 2, air was introduced as the second gas into the annealing furnace from the lower end thereof at 35 slm, and in a state where the temperature inside the annealing furnace was set to 1,000° C., the optical fiber was drawn at a fiber drawing speed of 2,000 m/min. In this case, the fluctuation in outer diameter of the optical fiber was 0.8 μm, which was significant, resulting in an inappropriate value. In Comparative Example 4, an argon gas was introduced as the second gas into the annealing furnace 20 from the lower end thereof at 35 slm, and in a state where the temperature inside the annealing furnace was set to 1,000° C., the optical fiber was drawn at a fiber drawing speed of 2,000 m/min. In this case, the fluctuation in outer diameter of the optical fiber was 1.2 μm, which was significant, resulting in an inappropriate value.

As above, in the annealing furnace, it could be confirmed that when the total flow rate of the second gas introduced through the gas introduction port was 3 slm or higher, a transmission loss of an optical fiber could be reduced. In addition, it could be confirmed that when each of the flow rates of the second gas per gas introduction port in the annealing furnace was 30 slm or lower, fluctuation in outer diameter of the optical fiber could be curbed.

### REFERENCE SIGNS LIST

1 Manufacturing apparatus
10 drawing furnace
13 First gas introduction mechanism
15 First gas supply unit
20 Annealing furnace
22 Heater
23, 24 Second gas introduction mechanism
23a, 24a Second gas introduction port
25 Second gas supply unit
F1, F2 Optical fiber
P Optical fiber preform

1. A method for manufacturing an optical fiber comprising:
drawing an optical fiber by heating an optical fiber preform inside a drawing furnace into which a first gas is introduced; and
annealing the optical fiber by causing the optical fiber to pass through an annealing furnace disposed downstream of the drawing furnace and adjusted to a temperature lower than a temperature at which the optical fiber preform is heated,
wherein in the annealing, a second gas having a lower heat conductivity than the first gas is introduced into the annealing furnace through one or more gas introduction ports such that a total flow rate becomes 3 slm or higher, and a flow rate of the second gas per gas introduction port is adjusted to 30 slm or lower.

2. The method for manufacturing an optical fiber according to claim 1, wherein the optical fiber having a temperature within a range of 1,300° C. to 1,650° C. is led to the annealing furnace in the annealing.

3. The method for manufacturing an optical fiber according to claim 1, wherein a temperature of the annealing furnace is set within a range of 800° C. to 1,400° C. in the annealing.

4. The method for manufacturing an optical fiber according to claim 1, wherein the optical fiber is led to the annealing furnace at a drawing speed of 2,000 m/min or faster in the annealing.

5. The method for manufacturing an optical fiber according to claim 1, wherein the first gas is helium gas, and the second gas is nitrogen, air, or an inert gas other than the helium gas.

6. The method for manufacturing an optical fiber according to claim 1, wherein the second gas is introduced into the annealing furnace through the gas introduction ports in the annealing.
